(19) United States
(12) Patent Application Publication
(10) Pub. No.: US 2020/0342382 A1
(43) Pub. Date: Oct. 29, 2020

(54) SYSTEM AND METHOD FOR BI-DIRECTIONAL TRANSFORMATION BETWEEN PROJECT DOMAIN AND PROCESS DOMAIN

(71) Applicant: INTROPRO VENTURES INC., Richmond (CA)

(72) Inventors: Igor Mikhaylovich DIANOV, New Westminster (CA); Illia GONCHAROV, Chemnitz (DE)

(21) Appl. No.: 16/753,683

(22) PCT Filed: Oct. 18, 2018
(86) PCT No.: PCT/CA2018/051315

§ 371 Date: Apr. 3, 2020

Related U.S. Application Data
(60) Provisional application No. 62/574,286, filed on Oct. 19, 2017.

(51) Int. Cl. G06Q 10/06; G06F 8/20

(52) U.S. Cl. CPC G06Q 10/06316; G06F 8/24

(57) ABSTRACT

A system and method are provided to map and transform any Gantt Project Plan tasks workflow with tasks, subtasks, milestones, temporal constraints, task relationships, task duration types, and resources into equivalent Business Process Modeling Notation (BPMN) XML model ready for deployment and execution by any BPMN-compliant engine. The method provides input Gantt models, necessary for an automation or manual tool, to implement explicit Gantt Project Plan conversion into executable BPMN process model with corresponding XML specification. A system and method are also provided for Gantt BPMN execution automation to track and monitor task, subtask and milestone completion using Gantt Project Management. The system and method can play an important role in adopting BPM for Gantt Project Management automation to eliminate human discretion, reduce project and task manual coordination to increase efficiency, productivity, human collaboration with Gantt BPM automation technology.

### CROSS-REFERENCE AND CLAIM OF PRIORITY

This application claims priority from U.S. provisional patent application 62/574,286 filed Oct. 19, 2017 for a “System and Method for Bi-Directional Transformation Between Project Domain and Process Domain”, which is expressly incorporated herein to the fullest extent permitted by law.

### BACKGROUND

The present invention is directed to a system and method for bi-directional transformation between a project domain, for example as embodied by a Gantt Business Project Plan having temporal constraints, task relationships, subtasks, task duration types, and task resources, and an equivalent project domain, for example as embodied in a Business Process Modeling Notation (BPMN) XML specification, ready for deployment and execution by any BPM engine with real-time transformation of BPM execution events back to the project domain.

### RELATED ART AND PROBLEM DESCRIPTION

Time is a critical problem in Project Management and the essential aspect for any business process, because it directly affects operation costs, losses of productivity, lack of coordination, missed deadlines or business opportunities.

To solve time planning and scheduling problem in Project Management, Gantt timeline has been successfully used world-wide since 1910 as an effective tool to specify the coordination and plan execution of projects with complex time constraints in a simple and intuitive way. Since 1995, organizations had widely adopted MS Project to help with time planning using Gantt timeline to help with scheduling automation.

Organizations adopt Business Process Management (BPM) for Project Management due to the growing need to automate and streamline time of business projects in order to save money. Still today, out-of-the-box, they face the following challenges:
BPMN Standard Lacks Time Dimension For Project Management
It is very difficult to specify and manage complex time constraints and relationships between the flow of tasks with different behaviors inside a large BPM process in a simple way due to the lack of BPMN time dimension. The lack of time dimension prevents adoption of any business process where automating temporal coordination of tasks in a complex business process with time constraints between tasks is essential
Gantt Project Management Software Lacks Automatic BPM Execution
Gantt timelines do not specify automatic behavior what to do when, due to project execution contingencies, any time constraint or time relationship between tasks is violated. Any task coordination or escalation action is left at the human discretion and requires manual coordination, which directly affects operation costs, losses of productivity, lack of coordination, missed deadlines or business opportunities

### Example Case

1. Project Design Effort: During process planning and modeling stage, Project Manager needs to work backwards from the target deadline date in order to determine earliest possible start date using Critical Path method (sequence of tasks that will take the longest to complete to execute the process) and schedule tasks and resources with real-life different temporal and relationship constraints, i.e.
Project Manager uses Gantt Project Management Software with temporal dimension for project design and testing the feasibility of executing the Gantt Project Model.
2. Process Design Effort: Process Designer uses Gantt model to manually transform all the Gantt tasks and resources constraints into BPMN process model that meets all temporal constraints and relationships specified in the Gantt model. Software Engineer will use BPMN process model to prepare, test and stage for deployment.
3. Execution Run-time Effort: When BPMN process model is deployed to BPM engine by Software Engineer, BPM software orchestrates tasks to assigned participants, the Project Manager needs to manually map BPM process audit reports to synchronize Gantt project timeline for reporting and risk monitoring. Any re

In this example case, design and run-time requires man-months of manual effort and human coordination between Project Manager, Process Designer, and Software Engineer.

The present invention is directed to these needs.

### SUMMARY

According to one aspect of the present invention, there is provided a system having a computing and communication resource, the computing and communication resource having a processor, a storage medium, and an application program stored on the storage medium comprising machine-executable code for execution by the processor, wherein the machine-readable code directs the processor to transform a project domain model into a process domain model.

This transformation may include transforming at least one of: temporal constraints, task relationships, subtasks, task duration types, and task resources.

The machine-readable code may further direct the processor to synchronize the project domain model to the process domain model.

This synchronization may include synchronizing at least one of a: process started event, process completed event, subprocess starter event, subprocess completed event, task created event, task assigned event, task completed event, call activity started event, call activity completed event, and signal fired event.

Further aspects and advantages of the present invention will become apparent upon considering the following drawings, description and claims.

### DESCRIPTION

The invention will become more fully illustrated by the following detailed description of non-limiting specific embodiments in conjunction with the accompanying drawing figures.

### BRIEF DESCRIPTION OF THE DRAWINGS

FIG. 1 is a UML sequence diagram of a transformation and synchronization between a Gantt model and a Business Process Model, embodying aspects of the present invention.

FIG. 2 is a UML class diagram of a Gannt Business Project model, embodying to aspects of the present invention.

FIG. 3 is a UML deployment diagram of a computing and communication resource for storing the Gantt Business Project model and performing transformation and synchronization between the Gantt model and the Business Process Model, embodying aspects of the present invention.

Additional smaller illustrations, for example charts, UML diagrams, and source code extracts, are provided in-line as part of the text of the description, for greater clarity, concision and precision of description.

### DETAILED DESCRIPTION

The structure and operation of various aspects of the invention will now be illustrated by explanation of specific, non-limiting, exemplary embodiments shown in drawing figures and described in greater detail herein. These include embodiments of computing and communication methods, systems, networks, nodes, resources, devices, classes, artifacts and objects specially characterized and configured to provide the technical solutions to support this kind of communication in this kind of application and to satisfy the constraints imposed. Those skilled in the art will recognize that the nature of this kind of communication and this kind of application produces specific technical problems that require solution, as will be described further below.

For greater clarity, concision and precision, the description includes inline with text additional annotations, for example in the form of charts, UML diagrams, and source code extracts.

Overview

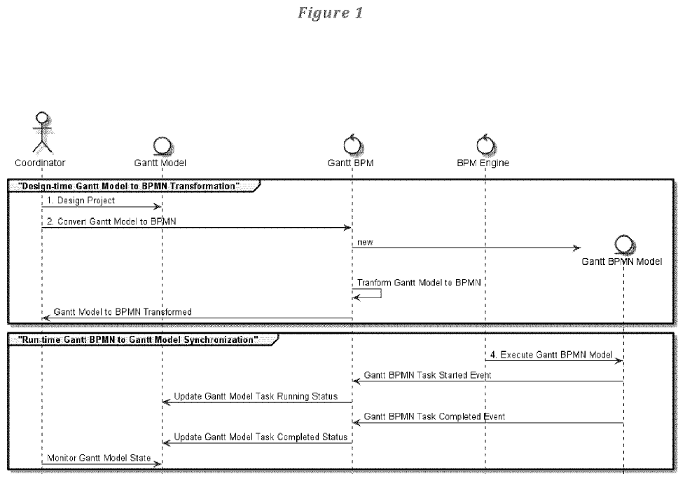

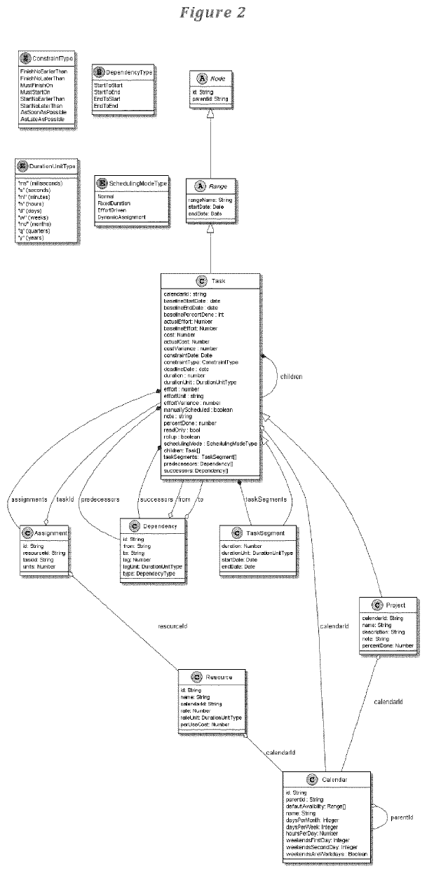

With reference to FIGS. 1 and 2, those skilled in the art will come to appreciate that the teachings herein play an important role in adopting BPM for Gantt Project Management automation to eliminate human discretion, reduce project and task manual coordination to increase efficiency, productivity, human collaboration with Gantt BPM automation technology all participants in the example case realize instant time to value:
Process Designer uses Gantt Project Management timeline to specify the required process design of all time-constrained tasks with resources and the ability to test the feasibility of executing the Gantt plan scheduling and critical path assessment feature.
With one-click, the Gantt BPM instantly transforms it to valid Gantt BPMN process model that meets the temporal constraints and task relationships specified in the Gantt plan.
During run-time, Gantt BPMN Model is deployed and executed in BPM Engine. The BPM Engine orchestrate tasks for all participants. When any task is started or completed in Gantt BPM Process, it automatically synchronizes state with Gantt Model instance.
Project Coordinator is now able to monitor progress and mitigate risks in real-time by observing Gantt Model state.

Deployment

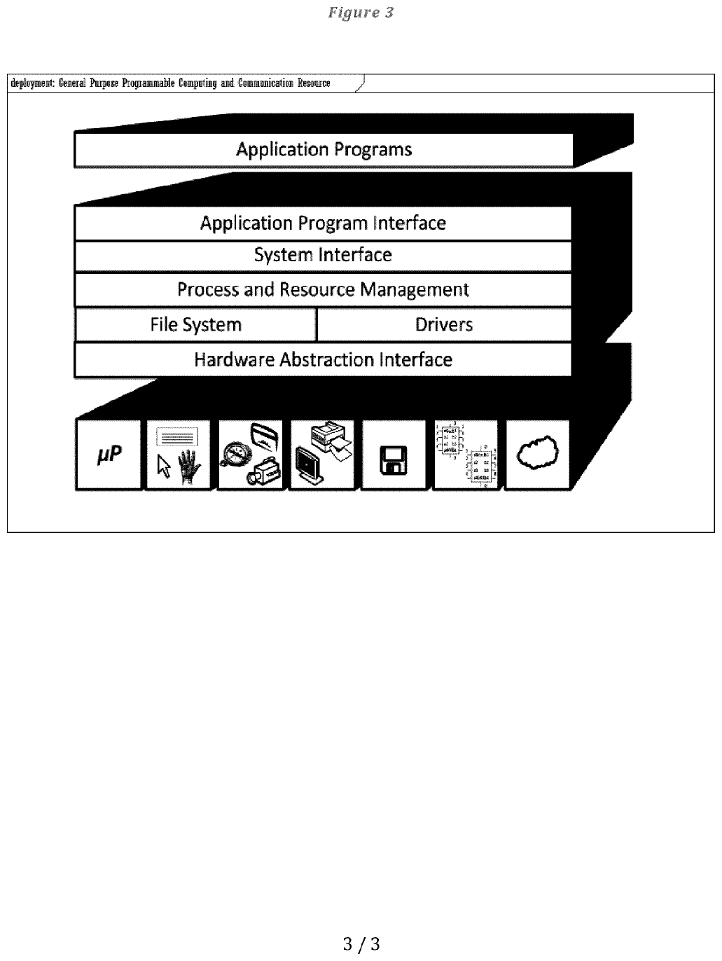

With reference to FIG. 3, according to one embodiment of aspects of the present invention, the system may be deployed on a discrete device, for example a workstation, a desktop computer, a laptop computer, a tablet or a smartphone.

According to another embodiment of aspects of the present invention, the system may be deployed as an internetwork (hereinafter “network”) of computing and communication resources. This network is the foundation of a computing and communication system, for example an enterprise data system. The network connects together a number of nodes, some of which nodes may be categorized for convenience as servers and some of which nodes may be categorized for convenience as clients. Participants in the system, whether human, robotic or cybernetic, for example, participate through appropriate nodes in the network

Those skilled in the art will recognize that the network could be scaled to include multiple servers for each node. Furthermore, a particular server might be spread across multiple physical locations (or jurisdictions), which might increase, decrease or change over time, including on-the-fly, depending on resource demands and network management decisions. The network could be provided as a managed network service.

Those skilled in the art will understand that in an internetworked system an action is often the result of coordinated activities occurring at multiple nodes in the system. In the case of a system built on the Internet, these nodes are often distributed ad hoc and unpredictably across multiple jurisdictions. The actions as described and claimed herein are intended to encompass at least: (a) actions performed directly and completely within the jurisdiction of the patent, (b) actions coordinated within the jurisdiction but with at least some activities performed outside the jurisdiction, (c) actions coordinated outside the jurisdiction but with at least some activities performed within the jurisdiction, and (d) actions performed for the benefit of a node within the jurisdiction or a person within the jurisdiction using that node. An example of such coordination would be serving a layout for a web page from one node and serving content for insertion into the layout from one or more other nodes, including through the use of server-side scripting, client-side scripting, and Asynchronous JavaScript and XML (AJAX) techniques.

In general, each of the clients might be a duly configured general purpose programmable computing and communication resource, sometimes called a processing unit or a computing or communication device, for example a workstation, a desktop computer, a laptop computer, a tablet or a smartphone. Alternatively, a client might be a more specific or purpose-built device, for example a wearable device, a media viewer, a home entertainment system, a gaming system, a smart appliance, a point-of-sale device, a payment authorization terminal such as a PIN pad, or a kiosk.

Each server might similarly be a duly configured general purpose programmable computing and communication resource, including a farm of computing devices or one or more virtualized computers embodied as processes operating on a physical general purpose programmable computing and communication device. Such farmed or virtualized computers might themselves be distributed over their own local or wide area network.

In essence, the servers and the clients are roles or functions performed in the system by properly configured computing and communication resources. Multiple roles or functions could be performed by one device and one role or function could be distributed over multiple devices. The specific character and configuration of a device (and more generally the hardware) and the network topology is important to the extent that it supports the performance of the assigned roles or functions.

The figure above shows an exemplary architecture for a typical computing and communication device, either as a discrete device or as embodying a node. These devices have a bottom hardware layer, a middle operating system layer and a top application program layer. Those skilled in the art will recognize the aspects in which like virtualized hardware and devices depart from like physical ones.

The hardware layer provides the device with computing and communication hardware, including: (a) a processor to execute processes of instructions and to compute data, (b) user-input hardware to receive input from a user, such as a keyboard (real or virtual), a selection device (for example a mouse, touchpad, touchscreen or other haptic sensor), or a microphone, (c) environmental sensors to receive input from the environment, such as a camera, a location sensor (e.g. GPS global positioning satellite receiver or cellular radio), an orientation sensor (e.g. compass, gyroscope), a movement sensor (e.g. GPS, accelerometer), or a scanner (e.g. an optical scanner, a magnetic scanner, a chip-and-PIN scanner, a field scanner (e.g. radio frequency identification—RFID, near field communication—NFC), a chemical scanner, or a biometric scanner), (d) user-output hardware to provide information to a user, such as a video display, a printer or a speaker, (e) mass storage such as electromagnetic, optical or nonvolatile solid-state media to store data and processing instructions, (f) memory such as read only memory and random access memory to store data and processing instructions, and (g) a network interface to support communication with other devices in accordance with known protocols such as code division multiple access (CDMA), global system for mobile communications (GSM), long term evolution (LTE), IEEE standard 802.11 (Wi-Fi), IEEE standard 802.3 (Ethernet), and transmission control protocol/internet protocol (TCP/IP), all interconnected by buses such as address and data buses and control lines such as interrupt and clock lines and such other connections and components as is conventionally required and known in the art.

Stored in a portion of the read only memory and the mass storage are the components of the operating system layer, for example LINUX® or Microsoft® Windows® server® or Mac® OS X server® for a device such as general purpose programmable computer configured as a server or LINUX® or Microsoft® Windows® or Mac® OS X® for a general purpose programmable computer configured as a client or even Microsoft® Windows Phone®, Apple® iOS®, Google® Android®, BlackBerry® QNX® or Symbian®, for a portable such client device. The operating system layer provides the basic instructions to direct the processor how to interact with the other hardware described above and more generally how to perform the functions of a communication and computing device, including storing, accessing and computing data, and communicating with other devices. The operating system may be configured or extended to provide a web services framework, such as for distributed computing, such as the Windows Communication Foundation application programming interface in the .NET Framework. Those skilled in the art will recognize that some of the functionality described herein can be well-implemented using advanced HTML standards with related caching and client-side logic. Much like HTML 5 now has standards to adhere to various screen resolutions and other controls, those skilled in the art will appreciate that future versions of HTML may have standardization around device accessibility for cameras, accelerometers, biometric receivers, compasses and other input, output and sensing components, and that future evolutions of HTML may have the ability for browser plug-ins or browser extended session support that provide similar services to current app notifications, even after a browser window might have been closed.

The operating system layer presents an application program interface to the application program layer, so the processor can execute more sophisticated combinations of processes under the direction of higher level application programs stored in mass storage and loaded into random access memory for execution, for example the processes that will be elaborated below. This layer may also include more purpose-specific application programming interfaces.

The structure of software aspects of the system were described above using an object-oriented paradigm. Those skilled in the art will recognize that there are many programming paradigms and analogous systems can be programmed in accordance with such paradigms without departing from the spirit of the present invention. For example, other programming paradigms include: agent-oriented, automata-based, component-based (including flow-based and pipelined), concatenative, concurrent computing (including relativistic programming), data-driven, declarative (including constraint, functional, dataflow (including cell-oriented and reactive) and logic (including abductive logic, answer set, constraint logic, functional logic, inductive logic, and uncertain inference (including markov logic and probabilistic logic))), event-driven (including service-oriented and time-driven), expression-oriented, feature-oriented, function-level, generic, imperative (including procedural), language-oriented (including discipline-specific, domain-specific, grammar-oriented (including dialecting) and intentional), metaprogramming (including automatic, reflective (including attribute-oriented) and template (including policy-based)), non-structured (including array and iterative), nondeterministic, parallel computing (including process-oriented), programming in the large/small, semantic, non-object oriented structured programming paradigms (including modular and recursive) and value-level.

### Description Summary

Thus, it will be seen from the foregoing embodiments and examples that there has been described a way to provide computing and communication infrastructure to support a system and method for bi-directional transformation between a project domain, for example as embodied by a Gantt Business Project Plan having temporal constraints, task relationships, subtasks, task duration types, and task resources, and an equivalent project domain, for example as embodied in a Business Process Modeling Notation (BPMN) XML specification, ready for deployment and execution by any BPM engine with real-time transformation of BPM execution events back to the project domain.

While specific embodiments of the invention have been described and illustrated, such embodiments should be considered illustrative of the invention only and not as limiting the invention. In particular, all quantities described have been determined empirically and those skilled in the art might well expect a wide range of values surrounding those described to provide similarly beneficial results.

It will be understood by those skilled in the art that various changes, modifications and substitutions can be made to the foregoing embodiments without departing from the principle and scope of the invention. For example, systems having more or less types of participants, nodes, artifacts, and classes may still fall within the scope of the invention.

While the invention has been described as having particular application for the embodiments described, those skilled in the art will recognize it has wider application.

1. A system having a computing and communication resource, the computing and communication resource comprising:
a. a processor,
b. a storage medium, and
c. an application program stored on the storage medium comprising machine-executable code for execution by the processor,
wherein the machine-readable code directs the processor to transform a project domain model into a process domain model.

2. A system as claimed in claim 1, wherein transform includes transforming at least one of:
a. temporal constraints,
b. task relationships,
c. subtasks,
d. task duration types, and
e. task resources.

3. A system as claimed in claim 1, wherein the machine-readable code directs the processor to synchronize the project domain model to the process domain model.

4. A system as claimed in claim 3, wherein synchronize includes synchronizing at least one of a:
a. process started event,
b. process completed event,
c. subprocess starter event,
d. subprocess completed event,
e. task created event,
f. task assigned event,
g. task completed event,
h. call activity started event,
i. call activity completed event, and
j. signal fired event.
